(19) United States
(12) Patent Application Publication
(10) Pub. No.: US 2014/0156753 A1
(43) Pub. Date: Jun. 5, 2014

(54) NOVEL META-SOCIAL NETWORK SYSTEM AND METHOD THEREOF

(71) Applicant: M.A.Y. Ltd., Yehud (IL)

(72) Inventors: Shai BEN-EFRAIM, Or Yehuda (IL); Gal SHVEBISH, Yehud (IL); David BEN_ELI, New York, NY (US); Ofer OVED, Givataylm (IL)

(73) Assignee: M.A.Y. Ltd., Yehud (IL)

(21) Appl. No.: 13/899,604

(22) Filed: May 22, 2013

Related U.S. Application Data
(60) Provisional application No. 61/651,006, filed on May 24, 2012.

(51) Int. Cl. H04L 12/58

(52) U.S. Cl. CPC H04L 51/32
USPC 709/204

(57) ABSTRACT

A method for matching individuals as member entities via a social network, using a computerized network having processing means for processing the unique data of the member entities in the social network, and outputting a matrix value for each of the member entities. The processing means is adapted for matching each of the matrix values for each of the member entities with another member entity with the value of closest fit or other criteria to form a pair of matching member entities, each of the pair of matching member entities comprising the Individual Seeker and the Individual Object.

### FIELD OF THE INVENTION

The present invention is in the field of browser matching individuals via social networks, more specifically, it relates to the field of matching using a browser plug-in via social networks.

### BACKGROUND

In recent years, social networks are a central tool in communicating between people in various fields. More specifically, affective matching between individuals for different purposes is highly needed, and currently, matching processes are done in a non-satisfactory manner, more specifically, the current social networks do not produce good compatibility parameters between different users.

US patent application US2009012925 discloses matching between social network users, however, it does not disclose matching by initial data supplied by the users, only by analysis of user behavior.

US patent application US2011087705 discloses a method and system for managing social networks, although the method connects between different social networks it does not connect between different users of the social networks.

There is therefore a long unmet need for a method and system which will provide good matching parameters upon supply of initial data and will be independent of a specific social network.

### SUMMARY OF THE INVENTION

It is one object of the current invention to disclose a computer readable medium (CRM) having instructions thereon for operating a computerized network, the network comprising
a. a Meta Data base (MDB) provided with
   i. storage means for storing a register of a plurality of Individual Seekers (PIS) and a plurality of Individual Objects (PIO); and
   ii. unique data associated with each of the PIS, PIO;
b. independent PIO gateways associated with external Third Party Host Sites (TPHS); the gateways are adapted to identify at least one of PIO, PIS on the TPHS; and
c. processing means for processing the unique data of at least one of PIO and at least one of PIS and outputting at least one value for at least one of (i) pair of at least one of PIO and at least one of PIS; and (ii) at least one of PIO
wherein the PIO gateways are adapted for identifying the TPHS; data processing means is adapted for freely associating at least a portion of the value to a corresponding to at least a portion of the PIO gateway; the processing means further adapted for freely associating at least one of the PIS with at least one of the PIO gateway on the TPHS, thereby enabling at least one of the PIS registered in the MDB to view either one of PIO , value and to communicate via external TPHS with at least one other the PIO registered in the MDB; at least one of the PIO endowed with TPHS identity selected by at least one of the PIS.

It is another object of the current invention to disclose the CRM as defined above, wherein the gateway is implemented by a mean selected from a group consisting of desktop software, Browser's plug in, Browsers extension, cell phone application or tablet application.

It is another object of the current invention to disclose the CRM as defined above, wherein the processing means of the network is adapted to send and associate at least a portion of the Individual's Object value, selected by the Individual Seeker, from the MDB to any gateway of the Individual Objects.

It is another object of the current invention to disclose the CRM as defined above, wherein the processing means of the network is adapted to iteratively send and associate at least a portion of the updated value of the Individual Objects selected by the Individual Seeker, from the MDB to the gateways of the Individual Object.

It is another object of the current invention to disclose the CRM as defined above, wherein the processing means for processing the unique data of the member entities in the network is adapted for outputting a matrix value for each of the member entities; the processing means adapted for matching each of the matrix values for each of the member entities with another member entity with the value of closest fit or other criteria to form a pair of matching member entities, each of the pair of matching member entities comprising the Individual Seeker and the Individual Object.

It is another object of the current invention to disclose the CRM as defined above, wherein the member entities in the MDB are interchangeably Individual Seekers and Individual Objects.

It is another object of the current invention to disclose the CRM as defined above, wherein the processing means is adapted to derive at least one numerological, astrological compatibility values from the unique data.

It is another object of the current invention to disclose the CRM as defined above, wherein the processing means is adapted to derive Sexual orientation compatibility values from the unique data.

It is another object of the current invention to disclose the CRM as defined above, wherein the processing means is adapted to derive genealogical closeness values from the unique data.

It is another object of the current invention to disclose the CRM as defined above, wherein the processing means is adapted to derive parental genetic compatibility values from the unique data.

It is another object of the current invention to disclose the CRM as defined above, wherein the processing means is adapted to derive psychological compatibility values from the unique data.

It is another object of the current invention to disclose the CRM as defined above, wherein the processing means is adapted to derive biological donor compatibility values from the unique data.

It is one object of the current invention to disclose a method for operating a computerized network comprising steps of
a. providing:
   1) a Meta Data base (MDB) provided with
      i. storage means for storing a register of a plurality of Individual Seekers (PIS) and a plurality of Individual Objects (PIO); and
      ii. unique data associated with each of the PIS, PIO;
   2) independent PIO gateways associated with external Third Party Host Sites (TPHS); the gateways adapted to identify the individual object and the individual seeker on the TPHS; and
   3) processing means for processing the unique data and outputting at least one value for at least one of (i) each pair of at least one of PIO and at least one of PIS; and (ii) at least one of PIO;
wherein the method further comprises steps of
b. adapting the PIO gateways for identifying the TPHS;
c. adapting the data processing means for freely associating at least a portion of the value to corresponding to at least a portion of the PIO gateway;
d. adapting the processing means for freely associating at least one of the PIS with at least one of the PIO gateway on the TPHS, therefore enabling at least one of the PIS registered in the MDB to view either one of PIO, value and to communicate via external TPHS with at least one other of the PIO registered in the MDB,
e. endowing the at least one of the PIO with TPHS identity selected by at least one of the PIS.

It is another object of the current invention to disclose the method as defined above, additionally comprising step of implementing the gateway by a mean selected from a group consisting of desktop software, Browser's plug in, Browsers extension, cell phone application or tablet application.

It is another object of the current invention to disclose the method as defined above, additionally comprising step of adapting the processing means of the network to send and associate at least a portion of the Individual's Object value, selected by the Individual Seeker, from the MDB to any gateway of the Individual Objects.

It is another object of the current invention to disclose the method as defined above, additionally comprising step of adapting the processing means of the network to iteratively send and associate at least a portion of the updated value of the Individual Objects selected by the Individual Seeker, from the MDB to the gateways of the Individual Object.

It is another object of the current invention to disclose the method as defined above, additionally comprising step of adapting the processing means for processing the unique data of the member entities in the network for outputting a matrix value for each of the member entity; adapting the processing means for matching each of the matrix value for each of the member entity with another member entity with value of closest fit or other criteria to form a pair of matching member entities, each of the pair of matching member entities comprising the Individual Seeker and the Individual Object.

It is another object of the current invention to disclose the method as defined above, wherein the member entities in the MDB are interchangeably Individual Seekers and Individual Objects.

It is another object of the current invention to disclose the method as defined above, additionally comprising step of adapting the processing means to derive at least one of astrological, numerological compatibility values from the unique data.

It is another object of the current invention to disclose the method as defined above, additionally comprising step of adapting the processing means to derive Sexual orientation compatibility values from the unique data.

It is another object of the current invention to disclose the method as defined above, additionally comprising step of adapting the processing means to derive genealogical closeness values from the unique data.

It is another object of the current invention to disclose the method as defined above, additionally comprising step of adapting the processing means to derive parental genetic compatibility values from the unique data.

It is another object of the current invention to disclose the method as defined above, additionally comprising step of adapting the processing means to derive psychological compatibility values from the unique data.

It is another object of the current invention to disclose the method as defined above, additionally comprising step of adapting the processing means to derive biological donor compatibility values from the unique data.

### BRIEF DESCRIPTION OF THE DRAWINGS

In order to understand the invention and to see how it may be implemented in practice, a few preferred embodiments will now be described, by way of non-limiting examples only, with reference to the accompanying drawings, in which:

FIG. 1 discloses a network for connecting individuals in a web-site; and

FIG. 2 shows a flow chart of a method for operating a computerized network.

### DETAILED DESCRIPTION OF THE INVENTION

The following description is provided so as to enable any person skilled in the art to make use of the invention and sets forth examples contemplated by the inventors of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The term “social networks” refers hereinafter to any website containing a plurality of individuals whose identities are recognizable by the website.

The term “gateway” refers hereinafter to any software program adapted to be installed on any computer readable medium and associate between an individual registered in a data base to another individual's profile in a social network presented in a browser.

The term “Third party host site” refers hereinafter to any website in the internet, more specifically; it refers to social network websites.

The term “computer readable medium” refers hereinafter to any medium that is capable of storing or encoding a sequence of instructions for execution by a computer and that cause the computer to perform any one of the methodologies of the present invention, it includes, but is not limited to, solid-state memories, optical and magnetic disks, and carrier wave signals.

The term “PIS” refers hereinafter to a plurality of Individual Seekers, wherein an individual seeker is a person who has some kind of interest in other people and he is active in the social networks about it. Thus, he is using the social networks in order to find other individuals, gain knowledge about them, and make initial contact with them.

The term “PIO” refers hereinafter to a plurality of Individual Objects, wherein an individual object is a person who has some kind of interest in other people and he is passive in the social media about it. Thus, he is waiting for other people to contact him.

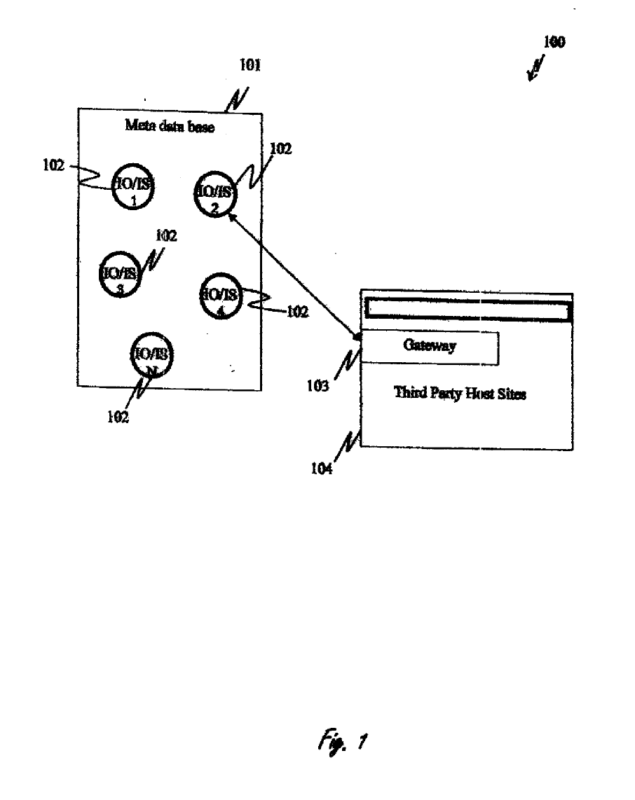

Reference is now made to FIG. 1 which illustrates in a non-limiting manner a computer readable medium (CRM) having instructions thereon for operating a computerized network 100, the network 100 comprising
a. a Meta Data base (MDB) 101 provided with
   i. storage means for storing a register of a plurality of Individual Seekers (PIS) 102 and a plurality of Individual Objects (PIO) 102; and
   ii. unique data associated with each of the PIS 102, PIO 102;
b. independent PIO gateways 103 associated with external Third Party Host Sites (TPHS) 104; the gateways 103 are adapted to identify at least one of PIO 102, PIS 102 on the TPHS 104; and
c. processing means for processing the unique data of at least one of PIO 102 and at least one of PIS 102 and outputting at least one value for at least one of (i) pair of at least one of PIO 102 and at least one of PIS 102; and (ii) at least one of PIO 102;

wherein the PIO gateways 103 are adapted for identifying the TPHS 104; data processing means is adapted for freely associating at least a portion of the value to a corresponding to at least a portion of the PIO gateway 103; the processing means further adapted for freely associating at least one of the PIS 102 with at least one of the PIO gateway 103 on the TPHS 104, thereby enabling at least one of the PIS 102 registered in the MDB 101 to view either one of PIO 102, value and to communicate via external TPHS 104 with at least one other the PIO 102 registered in the MDB 101; at least one of the PIO 102 endowed with TPHS 104 identity selected by at least one of the PIS 102.

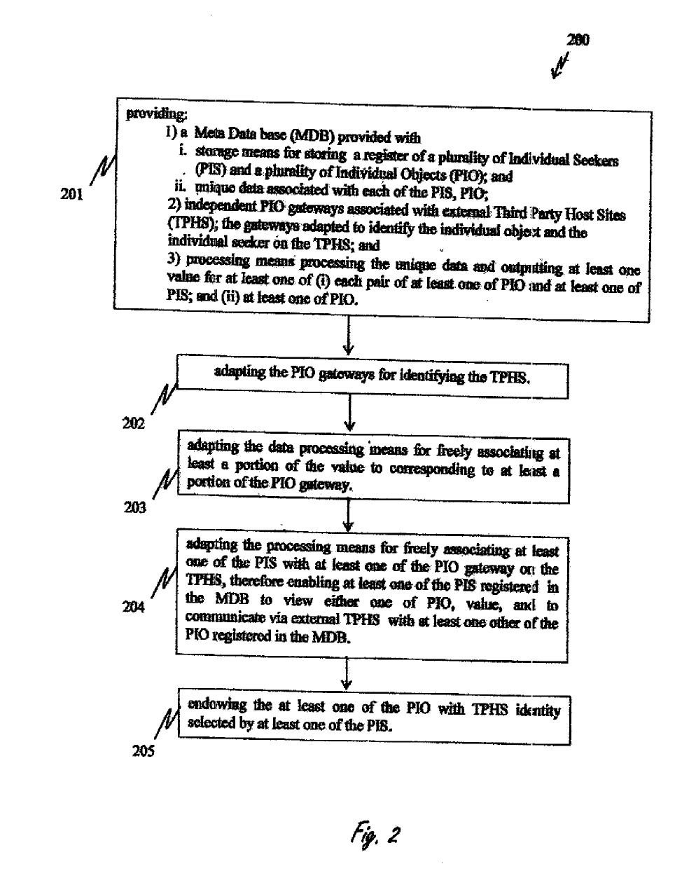

Reference is now made to FIG. 2 which shows in a non-limiting manner, a flowchart of a method 200 for operating a computerized network comprising:
a. step 201 of providing:
   1) a Meta Data base (MDB) provided with
      i. storage means for storing a register of a plurality of Individual Seekers (PIS) and a plurality of Individual Objects (PIO); and
      ii. unique data associated with each of the PIS;
   2) independent PIO gateways associated with external Third Party Host Sites (TPHS); the gateways adapted to identify the individual object and the individual seeker on the TPHS; and
   3) processing means processing the unique data and outputting at least one value for at least one of (i) each pair of at least one of PIO and at least one of PIS; and (ii) at least one of PIO;
wherein the method further comprises steps of
b. step 202 of adapting the PIO gateways for identifying the TPHS;
c. step 203 of adapting the data processing means for freely associating at least a portion of the value to corresponding to at least a portion of the PIO gateway;
d. step 204 of adapting the processing means for freely associating at least one of the PIS with at least one of the PIO gateway on the TPHS, therefore enabling at least one of the PIS registered in the MDB to view either one of PIO, value and to communicate via external TPHS with at least one other of the PIO registered in the MDB;
e. step 205 of endowing the at least one of the PIO with TPHS identity selected by at least one of the PIS.

In some embodiments of the current invention, the gateway is implemented by a means selected in a non-limiting fashion from a group consisting for example of desktop software, Browser's plug-in, Browsers extension, cell phone application or tablet application.

In some embodiments of the current invention, the processing means of the network is adapted to send and associate at least a portion of the Individual's Object value, selected by the Individual Seeker, from the MDB to any gateway of the Individual Objects.

In some embodiments of the current invention, the processing means of the network is adapted to receive data from the Individual Objects TPHS and update the Individual Objects unique data stored in the Meta data base thereby providing updated value.

In some embodiments of the current invention, the processing means of the network is adapted to iteratively send and associate at least a portion of the updated value of the Individual Objects selected by the Individual Seeker, from the MDB to the gateways of the Individual Object.

In some embodiments of the current invention, the processing means for processing the unique data of the member entities in the network is adapted for outputting a matrix value for each of the member entity; the processing means adapted for matching each of the matrix value for each of the member entity with another member entity with the value of closest fit or other criteria to form a pair of matching member entities, each of the pair of matching member entities comprising the Individual Seeker and the Individual Object.

In some embodiments of the current invention, the member entities in the MDB are interchangeably Individual Seekers and Individual Objects.

In some embodiments of the current invention, the processing means is adapted to derive from the unique data either one of: numerological compatibility, astrological compatibility, sexual orientation compatibility, genealogical closeness, parental genetic compatibility values, psychological compatibility values, biological donor compatibility values and any combination of the above.

In one embodiment of the current invention, a user (refers hereinafter as U) registered in a data base, that is, he enters a website in which he can leave some predetermined details. To this specific website, plurality of people are also registered, and some compatibility parameters are calculated between them.

After registration, the user U downloads and installs a plug-in into the computer, this plug-in is a website plug-in which connects between the user U and social networks in which the user U is surfing. For example, U opens a social network site, in this site he looks at another individual profile (refers hereinafter as IP), and this specific IP is also registered in the data base, the plugin recognizes the individual IP and displays upon his profile some of the matching parameters between U and IP as calculated by the data base. The parameters are presented in the profile as an additional layer on top of the social network page, and do not gain access directly into the user IP details or activity.

### Example 1

A young woman is surfing across the Facebook social network looking for a potential suitable lover. She comes across number of profiles of attractive young men. At each of these profiles she is presented with a compatibility bar indicating the specific potential relationship compatibility with that person. The compatibility bar is based upon Astrological Cross-Mapping between the young woman's Astrological map and that of her potential date.

### Example 2

A business woman is about to embark on a new business venture. She is contemplating partnering with another skilled professional. The business woman is a great believer in Numerology and would like to learn of her business compatibility with that potential partner. She looks for the business profile of the potential partner at the LinkedIn social network and in there presented with a compatibility bar indicating the potential business compatibility with that potential business partner. The compatibility bar is based upon Numerological Cross-Mapping between the business woman's Numerological map and that of her potential partner.

### Example 3

For obvious reasons many Gays refrain from exposing their sexual preferences among their personal profiles at leading mainstream social networks (such as Facebook). The invention would potentially allow to discreetly notifying a Gay person of the sexual orientation of another Gay person when coming across the Facebook profile of that person. This would allow the creation of an online Gay community that would rely on countless existing social networks.

### Example 4

The search for personal Genealogy at the era of online social networks is wide spreading. While encountering profiles at social networks of people of suspected similar origin and/or common family name—users of such an application would be able to view the DNA proximity to these and verify their common Genealogy.

### Example 5

It is common for singles to search the web for potential partners for child bearing. This search is performed mostly at dedicated social networks. One of the key considerations when searching for a suitable parental partner is the genetic compatibility aimed at bearing healthy children. Hence a genetic compatibility pre-screening would be beneficial when conducting such a search for a suitable parental mate. The proposed system would allow a member to view such a genetic compatibility indicator between him/her and a potential parental partner at the potential partner's profile page at the relevant social network web-site.

It will be appreciated by persons skilled in the art that embodiment of the invention are not limited by what has been particularly shown and described hereinabove. Rather the scope of at least one embodiment of the invention is defined by the claims below.

1. A computer readable medium (CRM) having instructions thereon for operating a computerized network, said network comprising
a. a Meta Data base (MDB) provided with
i. storage means for storing a register of a plurality of Individual Seekers (PIS) and a plurality of Individual Objects (PIO); and
ii. unique data associated with each of said PIS, said PIO;
b. independent PIO gateways associated with external Third Party Host Sites (TPHS); said gateways adapted to identify at least one of said PIS, said PIO on said TPHS; and
c. processing means for processing said unique of at least one said PIO and at least one said PIS and outputting at least one value for at least one of (i) pair of at least one said PIO and at least one said PIS; and (ii) at least one of said PIO
wherein said PIO gateways are adapted for identifying said TPHS; data processing means is adapted for freely associating at least a portion of said value to a corresponding to at least a portion of said PIO gateway; said processing means further adapted for freely associating at least one of said PIS with at least one of said PIO gateway on said TPHS, thereby enabling at least one of said PIS registered in said MDB to view either one of said PIO, said value, and to communicate via external said TPHS with at least one other said PIO registered in said MDB, said at least one of said PIO endowed with TPHS identity selected by said at least one of said PIS.

2. The CRM according to claim 1, wherein said gateway is implemented by a mean selected from a group consisting of desktop software, Browser's plug in, Browsers extension, cell phone application or tablet application.

3. The CRM according to claim 1, wherein said processing means of said network is adapted to send and associate at least a portion of said Individual's Object value, selected by said Individual Seeker, from said MDB to any gateway of said Individual Objects.

4. The CRM according to claim 3, wherein said processing means of said network is adapted to iteratively send and associate at least a portion of said updated value of said Individual Objects selected by said Individual Seeker, from said MDB to said gateways of said Individual Object.

5. The CRM according to claim 1, wherein said processing means for processing said unique data of said member entities in said network is adapted for outputting a matrix value for each said member entity; said processing means adapted for matching each said matrix value for each said member entity with another member entity with said value of closest fit or other criteria to form a pair of matching member entities, each said pair of matching member entities comprising said Individual Seeker and said Individual Object.

6. The CRM according to claim 1, wherein said member entities in said MDB are interchangeably Individual Seekers and Individual Objects.

7. The CRM according to claim 5, wherein said member entities in said MDB are interchangeably Individual Seekers and Individual Objects.

8. The CRM according to claim 1, wherein said processing means is adapted to at least one selected from a group consisting of (a) derive at least one of numerological compatibility values, astrological compatibility values, from said unique data; (b) derive Sexual orientation compatibility values from said unique data; and any combination thereof.

9. The CRM according to claim 1, wherein said processing means is adapted to derive genealogical closeness values from said unique data.

10. The CRM according to claim 1, wherein said processing means is adapted to derive parental genetic compatibility values from said unique data.

11. The CRM according to claim 1, wherein said processing means is adapted to derive psychological compatibility values from said unique data.

12. The CRM according to claim 1, wherein said processing means is adapted to derive biological donor compatibility values from said unique data.

13. A method for operating a computerized network comprising steps of
a. providing:
1) a Meta Data base (MDB) provided with
i. storage means for storing a register of a plurality of Individual Seekers (PIS) and a plurality of Individual Objects (PIO); and
ii. unique data associated with each of said PIS, said PIO;
2) independent PIO gateways associated with external Third Party Host Sites (TPHS); said gateways adapted to identify said individual object and said individual seeker on said TPHS; and
3) processing means for processing said unique data and outputting at least one value for at least one of (i) each pair of at least one of said PIO and at least one of said PIS; and (ii) at least one of said PIO;
wherein said method further comprises steps of
b. adapting said PIO gateways for identifying said TPHS;
c. adapting said data processing means for freely associating at least a portion of said value to corresponding to at least a portion of said PIO gateway;
d. adapting said processing means for freely associating at least one of said PIS with at least one of said PIO gateway on said TPHS, therefore enabling at least one of said PIS registered in said MDB to view either one of said PIO, said value, and to communicate via external said TPHS with at least one other said PIO registered in said MDB,
e. endowing said at least one of said PIO with TPHS identity selected by said at least one of said PIS.

14. The method according to claim 13, additionally comprising step of implementing said gateway by a mean selected from a group consisting of desktop software, Browser's plug in, Browsers extension, cell phone application or tablet application.

15. The method according to claim 13, additionally comprising step of adapting said processing means of said network to send and associate at least a portion of said Individual's Object value, selected by said Individual Seeker, from said MDB to any gateway of said Individual Objects.

16. The method according to claim 15, additionally comprising step of adapting said processing means of said network to iteratively send and associate at least a portion of said updated value of said Individual Objects selected by said Individual Seeker, from said MDB to said gateways of said Individual Object.

17. The method according to claim 13, additionally comprising step of adapting said processing means for processing said unique data of said member entities in said network for outputting a matrix value for each said member entity; adapting said processing means for matching each said matrix value for each said member entity with another member entity with said value of closest fit or other criteria to form a pair of matching member entities, each said pair of matching member entities comprising said Individual Seeker and said Individual Object.

18. The method according to claim 13, wherein said member entities in said MDB are interchangeably Individual Seekers and Individual Objects.

19. The method according to claim 17, wherein said member entities in said MDB are interchangeably Individual Seekers and Individual Objects.

20. The method according to claim 13, additionally comprising at least one step selected from a group consisting of (a) adapting said processing means to derive at least one of numerological compatibility values, astrological compatibility values, from said unique data; (b) adapting said processing means to derive Sexual orientation compatibility values from said unique data; (c) adapting said processing means to derive genealogical closeness values from said unique data; (d) adapting said processing means to derive parental genetic compatibility values from said unique data; (e) adapting said processing means to derive psychological compatibility values from said unique data; (f) adapting said processing means to derive biological donor compatibility values from said unique data; and any combination thereof.
